(19) United States
(12) Patent Application Publication
(10) Pub. No.: US 2008/0030623 A1
(43) Pub. Date: Feb. 7, 2008

(54) Robust reception of digital broadcast transmission

(76) Inventors: Kumar Ramaswamy, Princeton, NJ (US); Paul Gothard Knutson, Lawrenceville, NJ (US); Jeffrey Allen Cooper, Rocky Hill, NJ (US)

Correspondence Address: THOMSON LICENSING LLC, Two Independence Way, Suite 200, PRINCETON, NJ, 08540, US

(21) Appl. No.: 11/716,921

(22) Filed: Mar. 12, 2007

Related U.S. Application Data
(63) Continuation-in-part of application No. 10/486,400, filed on Jan. 15, 2004, now abandoned.
(60) Provisional application No. 60/306,586, filed on Jul. 19, 2001.

(51) Int. Cl. H04N 5/38; H04N 7/04

(52) U.S. Cl. 348/723; 348/470; 348/E05.093; 348/E07.04

(57) ABSTRACT

A method and apparatus for improving the reception of digitally modulated signals. A main signal and a supplemental signal are provided in the transmitter. The main signal contains both high priority and low priority data and the supplemental signal contains high priority data. The supplemental signal is advanced in time with respect to the main signal. The main and supplemental signals are sent from the transmitter to the receiver modulated on a signal. At the receiver, the supplemental signal is stored in a buffer. If the main signal is undesirably changed during transmission, corresponding portions of the high priority data of the supplement signal are substituted for the undesired portions of the main signal.

### CROSS-REFERENCE TO RELATED APPLICATIONS

This application claims the benefit of U.S. Provisional Application 60/306,586 filed Jul. 19, 2001 and PCT International Application PCT/US02/22723 filed Jul. 17, 2002. This application is a continuation-in-part application of U.S. patent application Ser. No. 10/486,400 filed on Jan. 15, 2004.

### BACKGROUND OF THE INVENTION

1. Field of the Invention

The present invention relates to a system for improving the reception of the signal used in digital television. More particularly, the present invention is useful in mobile digital television receivers.

2. Discussion of Related Art

Any terrestrial TV system must overcome a number of problems in transmitting signals to a receiver. For example, the United States has adopted eight-level vestigial side band (8-VSB) modulation, as proposed by the Advanced Television Systems Committee (ATSC), as its terrestrial digital television system modulation standard. The VSB system, being a single carrier modulation system, is susceptible to fading caused by multipath and signal attenuation. Any of the signal fading that is frequency selective may be corrected by equalization techniques. However this can result in degraded performance when fading occurs. If the fade is deep, wide and long enough in duration, however, the signal will be lost and the demodulator system in the TV receiver will lose synchronization. Such fading is particularly severe in mobile reception of the signal used in digital television.

The present invention seeks to overcome these problems by utilizing two sets of program material from a source in a transmitter. One of the sets is delayed in time with respect to the other. Thus, if the delayed set is used for reception and fading occurs, the set that is advanced in time can be substituted for the faded or missing portion of the signal.

While the detailed description of the current invention below focuses on the details of the 8-VSB system, it must be recognized that the solution of the current invention is equally applicable to any digital broadcast transmission system that is subject to a fading channel environment.

### SUMMARY OF THE INVENTION

In accordance with principles of the present invention a method and apparatus for improving the reception of digitally modulated signals operates as follows. A main signal and a supplemental signal are provided in the transmitter. The signals may be substantially identical except that the supplemental signal is advanced in time with respect to the main signal. The main and supplemental signals are sent from the transmitter to the receiver modulated on a signal. At the receiver, the supplemental signal is stored in a buffer. If the main signal is undesirably changed during transmission, corresponding portions of the supplement signal are substituted for the undesired portions of the main signal.

### BRIEF DESCRIPTION OF THE DRAWINGS

FIG. 1 is a schematic diagram of a VSB transmitter incorporating the principles of the present invention. FIG. 1 includes sub FIG. 1A having an MPEG Encoder and FIG. 1B having a hierarchical source encoder;

FIG. 2 is a schematic diagram of a VSB receiver incorporating the principles of the present invention; and

FIG. 3 is an illustration of groups of video packets received by the receiver wherein a fade has occurred during transmission.

### DETAILED DESCRIPTION OF THE INVENTION

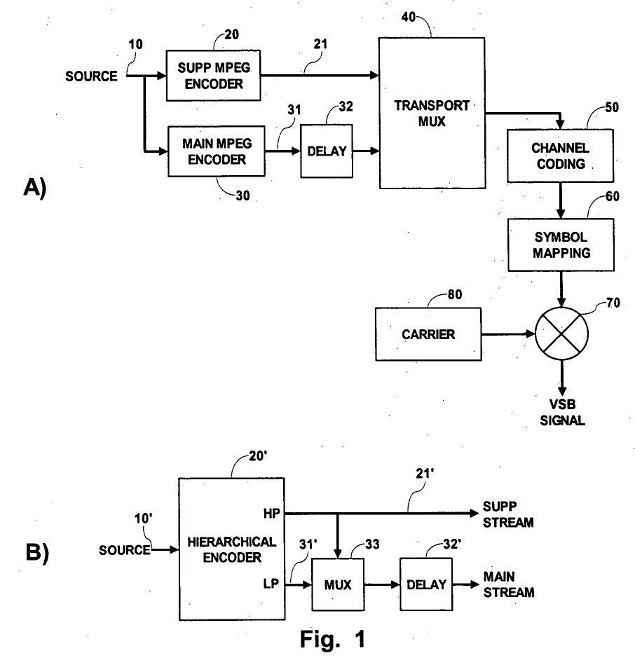

Referring to the drawings and more particularly to FIG. 1A, a schematic diagram of a transmitter incorporating the principles of the present invention is shown. The transmitter operates in accordance with the provisions of the Advanced Television Standards Committee (ATSC) Digital Television Standard dated Sep. 16, 1995, which is incorporated herein by reference. The digital television system includes three sections namely a source encoding and compression section a transport multiplexing section and an RF/transmission section.

The source material is applied on an input conductor 10 to an MPEG encoder 20 which provides the source encoding and compression, typically in accordance with MPEG standards, e.g. MPEG-2. The source material can include video and audio signals, for example, which are encoded in the encoder 20 into a digital data stream. The encoding can utilize known bit rate reduction methods and compression techniques which are appropriate for the particular signals involved. The compressed data stream provided from the encoder 20 is divided into packets of information, each packet including data identifying that packet.

Also in accordance with the principles of the present invention, a second encoder 30 is provided for the source material 10. In the encoder 30 the source material is encoded into a digital packet data stream in the same manner as in the encoder 20. However the output from the encoder 30 is applied on a conductor 31 to a packet buffer 32 which delays the data stream from the encoder 30 in time with respect to the output signal from the encoder 20. The output signal from the encoder 20 is identified as the supplemental signal while the output of the encoder 30 is identified as the main signal.

The output from the encoder 20 is applied on a conductor 21 to a first input of a transport multiplexer 40 and the output from the packet buffer 32 is applied to a second input of the transport multiplexer 40. Additional data signals (not shown) could also be applied to the multiplexer 40, for example, control data to be utilized in the DTV receiver. The data streams supplied to the transport multiplexer 40 are multiplexed into a single data stream by the transport multiplexer 40.

The output of the multiplexer 40 is channel coded and modulated by the channel coding section 50, the symbol mapping section 60, and the mixer 70 utilizing the carrier oscillator 80. These circuits also insert the various “helper” signals that will aid the 8-VSB receiver in accurately locating and demodulating the transmitted RF signal. These include the ATSC pilot tone, segment sync, and frame sync components.

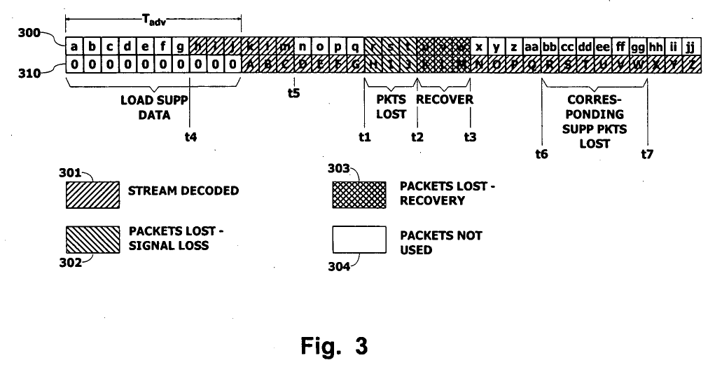

The main signal, as it is transmitted, is shown in FIG. 3 as 310 and runs from “A” to “Z”. The alphabetic sequence represents the time ordered sequence of video packets. The supplemental signal, as it is transmitted, is shown in FIG. 3 as 300 and runs from “a” to “jj”. In the embodiment illustrated in FIG. 3, the supplemental sequence is advanced in time by more than 6 packet times, and more specifically, is illustrated in FIG. 3 as being advanced by 10 packet times.

In accordance with the principles of the present invention, the method of transmitting two separate substantially identical signals, shifted in time is identified as “staggercasting”. Thus, FIG. 3 represents a staggercasted transmitted signal.

The main stream 310 of information and the supplemental stream 300 of information can be identical except for information in each packet to identify them. However in order to conserve channel bandwidth, the main stream could contain data representing video and/or audio at “full resolution” while the supplemental stream would contain reduced resolution data.

Instead of using the encoders 20 and 30 as shown in FIG. 1A it is possible to also use a hierarchical coding method to supply the main and supplemental channels, as illustrated in FIG. 1B. The main channel 310 would advantageously be supplied with both high priority and low priority components but the supplemental channel 300 would have only the high priority components. The main channel may also contain high priority data which is of lower resolution (or quality) and low priority data which is of higher resolution (or quality), while the supplemental channel may only contain high priority data which is of lower resolution (or quality).

FIG. 1B shows the source material being applied via the terminal 10′ to the hierarchical source encoder 20′. The output on the conductor 21′ is the supplemental, time-advanced, stream 300 while the output on the conductor 31′ is the main stream 310. Note that the main stream 310 is delayed in the packet buffer 32′. In this embodiment, the supplemental channel would have only the high priority information on conductor 21′ while the main stream would include both the high priority information from conductor 21′ and the low priority information from conductor 31′ as combined in the multiplexer 33. The supplemental output from the hierarchical source encoder 20′ is applied to a first input of the transport multiplexer 40 while the output from the buffer 32′ would be applied to the second input of the transport multiplexer 40, as shown in FIG. 1A. Otherwise the transmitter functions are identical.

The use of hierarchical source coding permits the high priority data to appear in both the main and supplemental channels while all the low priority data is also available only in the main channel. Images transmitted by such a system could be displayed on mobile devices such as personal digital assistants equipped with VSB demodulators.

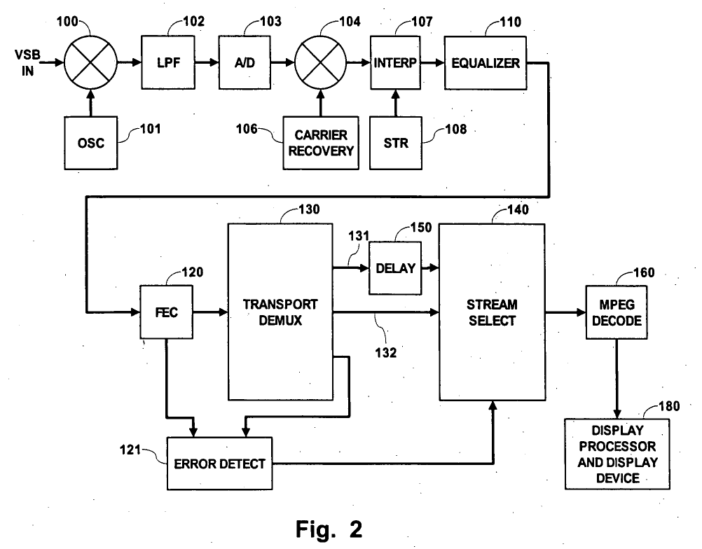

Referring now to FIG. 2 a schematic diagram for a VSB receiver incorporating the principles of the present invention is illustrated. In the 8-VSB transmitted signal, the digital information is transmitted exclusively in the amplitude of the RF envelope and not in the phase. The eight levels of the transmitted signal are recovered by sampling only the I-channel or in-phase information.

In the receiver shown in FIG. 2, the transmitted signal is demodulated by applying the reverse principles that were applied in the transmitter. That is the incoming VSB signal is received, downconverted, filtered and then detected. The segment and frame syncs are recovered. This is accomplished by the mixer 100, the local oscillator 101, the lowpass filter 102, the analog to digital converter 103, the mixer 104 and the carrier recovery circuit 106 as well as the interpolator 107 and the symbol timing recovery circuit 108, all in a known manner.

The output of the interpolator 107 is applied to the equalizer 110. The segment sync signal aids in the receiver clock recovery while the field sync signal is used to train the adaptive equalizer 110. The output of the equalizer 110 is applied to a forward error correction circuit (FEC) 120. The error corrected signals provided by the forward error correction circuit 120 are applied to and utilized in the transport demultiplexer 130. The output from the transport demultiplexer 130 includes both the supplemental stream signals on conductor 131 and the main stream signals on conductor 132. Under normal circumstances, the main stream signals are applied directly to the stream select circuit 140 while the supplemental signals are applied to a packet buffer delay circuit 150 which has a delay that matches the time period by which the supplemental signal is advanced in the transmitter. Accordingly the two streams applied to the stream select circuit 140 are now aligned in time.

The stream select circuit 140 normally is conditioned to pass the main stream signals to the MPEG decoder 160. If, however, a fading event occurs in the received VSB signal, then the main stream signals will be degraded, possibly to the point of being unusable. If the main stream signals become unusable, then the stream select circuit 140 will be conditioned to pass the buffered supplemental stream signals to the MPEG decoder 160. This is determined by the error detection circuit 121 connected to the outputs of the forward error correction circuit 120 and the transport demultiplexer 130. By this process, the corresponding portions of the high priority data of the supplemental signal stored in the buffer is substituted for any undesirably changed portions of the main stream signal. Thus, the data integrity of the main stream is maintained essentially intact.

The occurrence of a fading event can be detected by a number of possible measures in the physical layer. For example, a signal-to-noise ratio detector (SNR) may be used. This would be detected as a change in amplitude of the processed main signal. As another example, it is possible to use a bit-error rate detector. In yet another example, it is possible to use the undecodable error flag indication from the forward error correction system. When the circuit 121 determines that the main signal is corrupt it instructs the stream select circuit 140 to utilize the supplemental channel data.

The use of the supplemental data will continue until either the data in the buffer 150 is exhausted, or the receiver recovers and the main channel is restored to a predetermined quality threshold. It is evident that to be prepared for another fade in the main stream signal, once the receiver recovers it must stay recovered long enough to permit the supplemental packet buffer 150 to refill. The delay introduced into the main signal must be long enough to cover the expected time duration of fading events while not taking a long time period to recover from such fading events. In a preferred embodiment, the time delay introduced to the main signal by the packet buffer 32 or 32′ in the transmitter and the packet buffer delay 150 in the receiver may be selected to be between around 500 ms and a few seconds.

Also shown in FIG. 2 is a block representing a display processor and display device 180 which receives the output of the MPEG decoder 160 and develops decoded image data for an onscreen display image to be displayed On the display device, and decoded sound data to be reproduced on a speaker, in a conventional manner.

Referring now to FIG. 3, an illustration is provided of the staggercasting principles in a packet stream. FIG. 3 is a time diagram with the groups of video and/or audio packets representing the supplemental sequence (300) being advanced in time with respect to the main sequence (310) and, as noted above, running from “a” to “jj”. It can be seen that the supplemental channel 300 illustrated in the upper portion of the diagram is advanced in time by a time period “T_{adv}” of roughly ten packets in this example.

The main channel 310 is represented by the packets “A” to “Z” in the lower portion of the diagram where packet A in the main channel 310 corresponds to packet a in the supplemental channel, packet B in the main channel corresponds to packet b in the supplemental channel, and so forth. In FIG. 3 the first ten packets in the main channel 310 are indicated as zero since this is the time period by which the main channel 310 is delayed in the transmitter. This is the time period during which packets “a” to “j” are loaded into the buffer 150 in the receiver prior to the reception of the first corresponding packet “A” in the main stream 310. One skilled in the art will understand, however, that the main stream 310 may contain main packets corresponding to preceding packets in the supplemental channel.

FIG. 3 shows an example of a complete fade of the VSB signal in its transmission from the transmitter to the VSB receiver. The fade begins at time t1, and ends at time t2. After the fade, however, the circuitry in the receiver requires recovery time to resynchronize its clock to the received signal and reacquire error. correction lock. This recovery time begins at time t2, after the fade ends, and continues until time t3. The illustrated fade in the packet sequences, thus, causes the loss of six packets from both the main 310 and supplemental 300 channels. That is, in the main channel, packets H-M are lost: packets H, I, J are lost due to the fade and packets k, L, M are lost due to the demodulator and FEC recovery; and in the supplemental channel, packets r-w are lost for the same reasons.

However, it may be seen that, supplemental packets h-m, corresponding to main packets H-M, were received from time t4 to time t5, before the fade began and, therefore, are stored in the packet buffer 150. Because the supplemental packet sequence 300 has been advanced by more than 6 packets, which is the duration of the exemplary fade and reacquisition, the supplemental sequence h-m can be read from the packet buffer 150 when the main sequence H-M is lost due to the fading event.

The system is vulnerable to fades until the supplemental buffer 150 is repleted. This is because both the main and supplemental streams (and any others in the transport stream) were lost in the fade. More specifically, from time t6 to t7, the receiver receives main packets R-W. However, as described above, the corresponding supplemental packets r-w were lost during the fade. Thus, there are no supplemental packets stored in the packet buffer 150, and no protection for fades is available, for this time period. Full protection is available again after time t7. Additional supplemental streams, advanced by different time periods, could be used to ride out multiple close successive fades at the expense of consuming more bandwidth.

Also shown in FIG. 3 are shadings, which help to identify the processing of respective packets in the main and supplemental streams. The packets shaded as illustrated by shading 301 are the packets decoded by the MPEG decoder 160 at the receiver. The packets shaded as illustrated by the shading 302 are packets that are lost due to the loss of signal in transmission. The packets shaded as illustrated by the shading 303 are packets that are lost due to receiver re-acquisition while the unshaded boxes (shading 304) are packets that are available in either the main or the supplemental channels, but not decoded by the MPEG decoder 160.

The concept of using a supplemental signal to contain information to be processed during a fade event provides the same quality or a graceful degradation of the image. A lower quality supplemental signal requires lower throughput and less bandwidth to transmit than the full resolution main signals, but the lower quality image from the supplemental signal is slightly degraded from the full resolution image of the main signal. It is also conceivable to use a signal staggered in time of the same quality and even with a different compression format.

It is clear that the method and apparatus incorporating the principles of the present invention as described above helps to correct some of the weaknesses in the VSB system or any other modulation system that is susceptible to fading in a transmission channel. The VSB system is a single carrier modulation system and accordingly is susceptible to fading caused by multipath and signal attenuation. The use of the equalizer corrects many frequency selective fades but this is at the expense of increasing noise in the bands when actual fading occurs. If the fade is deep, wide and long enough in duration the modulator system can lose synchronization and the signal will be lost.

In accordance with the principles of the present invention, by having an advance copy of the program material in memory, it is possible to continue demodulating by switching to the advanced (supplemental) transport system. Thus the demodulator will continue to try to recover and if the fade is of modest duration the main stream will come back on line before the stored advance stream is exhausted. When the main program packets are available, the decoder will resume demodulating the mainstream and begin buffering the advanced packets of the supplemental stream awaiting the next disruption in the received signal.

The described method and apparatus are particularly useful for mobile reception of the VSB signal. It is evident that mobile receivers are prone to severe fading as the receiver is moved through different areas. This can cause interruption of the received signal. As noted above, the apparatus and method according to the principles of the present invention provide a means of graceful degradation of this received program under temporary loss of signal due to fading.

This approach utilizes the transmission of a synchronously encoded, optionally reduced resolution, advanced set of program material from the same source, called the supplemental signal. The technique is applicable to any streaming data but is directly useful for video and audio since lower resolution material could be used to conserve bandwidth. This is because the apparatus and method according to the principles of the present invention is concerned with the nature of the signals being transmitted. As also noted above, this system could be particularly useful to users of wireless personal digital assistants and entertainment digital assistants.

While the present invention has been described with respect to a particular embodiment and a particular illustrative example it is evident that the principles of the present invention may be embodied in other arrangements without departing from the scope of the present invention as defined by the following claims.

1. A method for improving the reception of transmitted digital broadcast signals, comprising the steps of:
producing a first set of program material from a first source in a transmitter containing high priority and low priority data;
producing a second set of program material from said first source in said transmitter containing high priority data;
time delaying said first set with respect to said second set before transmission;
transmitting said delayed first set and said second set of program materials on a signal for reception by a receiver;
applying said first set of program materials received in said receiver to reception channels of said receiver;
storing said second set of program materials received in said receiver in a buffer in said receiver;
detecting an undesired change in said received first set of program materials; and
substituting corresponding portions of the high priority data of said signal stored in said buffer for any undesirably changed portions of said first set of program materials.

2. A method as claimed in claim 1 wherein the high priority data in the first set of program material and the second set of program material are identical.

3. A method as claimed in claim 1 wherein said first set of program material is produced with a different quality than said second set of program material.

4. A method as claimed in claim 3 wherein the quality of said first set of program material is higher than the resolution of said second set of program material.

5. In a receiver, a method for improving the reception of signals transmitted in the form of synchronously encoded main and supplemental signals, said signals being staggered in time with said supplemental signal being in advance of said main signal, wherein said main signal contains high priority and low priority data and said supplemental signal contains high priority data, comprising the steps of:
storing said supplemental signal in a buffer in the receiver;
processing said main signal in said receiver in a manner to reproduce said main signal;
detecting an undesired change in the processed main signal; and
substituting corresponding portions of the high priority data of said stored supplemental signal for any undesirably changed portions of said main signal.

6. A method as claimed in claim 5 wherein said undesired change is a change in a quality of said processed main signal and said change is detected by a quality measure of said processed main signal.

7. A method as claimed in claim 6 wherein said quality measure is one or more of a signal-to-noise ratio, bit error rate or packet error rate measure.

8. A method as claimed in claim 5 wherein said main signal and said supplemental signal have different resolutions.

9. A method as claimed in claim 8 wherein the resolution of said main signal is higher than the resolution of said supplemental signal.

10. A system for improving the reception of a digital signals comprising:
means for producing a first set of program material from a source in a transmitter containing high priority and low priority data;
means for producing a second set of program material from said source in said transmitter containing high priority data;
means for delaying said first set in time with respect to said second set;
means for transmitting a signal carrying said delayed first set and said second set of program material;
a receiver having a first and a second channel for receiving said transmitted signal, said second channel having a buffer circuit for storing said second set of program material, and said first channel including means for processing said first set of program material to reproduce said first set of program material;
a detector in said receiver for detecting any undesired change in said processed first set; and
means in said receiver for substituting corresponding portions of the high priority data of said stored second set for any undesirably changed portions of said first set.

11. A system as claimed in claim 9 wherein the high priority data in the first set of program material and the second set of program material are identical.

12. A system as claimed in claim 9 wherein the resolution of said first set of program material is different from the resolution of said second set of program material.

13. A system as claimed in claim 11 wherein the resolution of said first set of program material is higher than the resolution of said second set of program material.

14. A receiver for improving the reception of a signal transmitted in the form of synchronously encoded main and supplemental signals, said signals being staggered in time with said supplemental signal being in advance of said main signal, wherein said main signal contains high priority and low priority data and said supplemental signal contains high priority data, comprising:
a buffer in said receiver for storing said supplemental signal;
a signal processor in said receiver for processing said main signal in a manner to reproduce said main signal;
a detector in said receiver for detecting any undesired change in said processed main signal; and
means coupled to said detector for substituting corresponding portions of the high priority data of said stored supplemental signal for any undesirably changed portions of said main signal.

15. Apparatus as claimed in claim 13 wherein said undesired change in said main signal is a change in the amplitude of said main signal and said detector includes one or more of a signal-to-noise ratio, bit error rate and packet error.
